(19) United States
(12) Patent Application Publication
(10) Pub. No.: US 2016/0341812 A1
(43) Pub. Date: Nov. 24, 2016

(54) SINGLE TRANSACTION AOA/TOA/DOPPLER TAGGING TRACKING AND LOCATING

(71) Applicant: SANTA MONICA SEMICONDUCTOR, Santa Monica, CA (US)

(72) Inventors: Lawrence J. Karr, Santa Monica, CA (US); Andrew C. Barber, Venice, CA (US)

(21) Appl. No.: 15/160,657

(22) Filed: May 20, 2016

Related U.S. Application Data
(60) Provisional application No. 62/164,628, filed on May 21, 2015.

(51) Int. Cl. G01S 5/02; G01S 5/10

(52) U.S. Cl. CPC G01S 5/0294; G01S 5/0268; G01S 5/0252; G01S 5/10

(57) ABSTRACT

With respect to electronic tag location and tracking, this invention solves moving target and two-fold angle ambiguity without the use of bulky antenna arrays. A multi-element antenna system with fore and aft placement of the elements separated by about ¼ to ½ wave provides an angle of arrival. Antenna selection treats the multiple elements as a single electronically translatable element with an omnidirectional pattern. The elements may be oriented to line up with the fuselage of an aircraft. The antenna elements may be skewed from fore to aft to resolve ambiguity observed with static targets. The apparatus uses successive packets whose content is known at the platform's receiver so that the signal correlation functions are directly comparable. Identical successive packets or different packets of the same length and from the same sequence family may be used. The system may be rapidly calibrated with existing system components.

### REFERENCE TO RELATED APPLICATION

This application claims priority from U.S. Provisional Patent Application Ser. No. 62/164,628, filed May 21, 2015, the entire content of which is incorporated herein by reference.

### FIELD OF THE INVENTION

This invention relates generally to electronic tag location and, in particular, to apparatus and methods for accurately locating and tracking static and dynamic tags without the use of bulky antenna arrays.

### BACKGROUND OF THE INVENTION

It is difficult to accurately locate moving tags, especially if those tags must operate in GPS-denied environments.

U.S. Pat. No. 7,646,330 and related patents describe a two-way Time of Arrival and Doppler tagging tracking and locating system which can locate static targets from an airborne platform to a two-fold ambiguity in a single, brief transaction. This system places tags on a sphere whose radius is the speed of light times half the round-trip time. The system also uses round-trip Doppler to produce a cone centered on the aircrafts heading. The intersection(s) of these figures with the earth's surface results in excellent position data subject to the two fold ambiguity.

The situation with moving tags is different, since the Doppler is determined by the relative velocities of the tag and the airborne platform. With tags in motion, direction information is distorted, and, with rapid tag motion, unavailable. Effective tracking of moving targets generally requires the use of two aircraft so that two round-trip distance spheres intersect at some point on the earth's surface.

Again, with static targets, the system has an inherent angle ambiguity since Doppler gives a direction cosine, which is two-valued in this system.

### SUMMARY OF THE INVENTION

With respect to electronic tag location and tracking, this invention solves moving target and two-fold angle ambiguity without the use of bulky antenna arrays. A multi-element antenna system with fore and aft placement of the elements separated by about ¼ to ½ wave provides an angle of arrival, which is less accurate than Doppler derived angles, but remains valid for moving targets. Antenna selection treats the multiple elements as a single electronically translatable element with an omnidirectional pattern. The elements may be oriented to line up with the fuselage of an aircraft, for example.

The apparatus is used for accurately locating a tag, including a moving tag, transmitting packets of information at a packet rate using phase-coherent signaling on a carrier frequency. At least two antenna elements, positioned fore and aft relative to a tag to be located, are spaced apart by about a ¼ to ½ wave of the carrier frequency. Electronic circuitry receives signals from the antenna elements to determine an angle of arrival (AOA) and the difference in the distance to the tag from each antenna position. In the preferred embodiment the antenna elements are skewed from fore to aft to resolve ambiguity observed with a target that is not moving.

The apparatus further preferably includes an antenna element selector switch to commutate the signals from the two antenna elements at the packet rate or an integer submultiple thereof. Assuming the packets are composed of lengthy codes, and the switching occurs at synchronous or integer sub-synchronous packet rates, the captured sequences are substantially identical from a source point of view.

Various techniques may be used to further enhance accuracy. The electronic circuitry may be operative to derive an angle to the tag based upon Doppler processing and compare the derived angle to the AOA. If the difference between the derived angle and the AOA is above a predetermined discrepancy, assume the target is moving and use the AOA as an angle measurement. If the derived angle and the AOA are in agreement, assume the tag is static and use the Doppler derived angle information. The system may further including an electronic compass to determine the alignment of the antenna elements, and/or tag(s) operative to transmit barometric data.

### BRIEF DESCRIPTION OF THE DRAWINGS

FIG. 1 is a schematic diagram of the preferred embodiment of the invention. The schematic includes a compass chip which is needed for antenna orientation; and

FIG. 2A is a “front” view of the antenna system illustrating a slight fore-aft skew;

FIG. 2B is a side view of the antenna elements of FIG. 2B; and

FIG. 2C shows the ¼ wave antenna rods mounted onto a printed circuit board. A tiny “radome” protects the assembly from wind and rain while making the antenna elements inconspicuous.

### DETAILED DESCRIPTION OF THE INVENTION

This invention broadly solves both the moving target problem and the two-fold angle ambiguity problem without the use of bulky antenna arrays. A two-element “blade” antenna system with fore and aft placement of the elements separated by about ¼ to ½ wave provides an angle of arrival, which is less accurate than Doppler derived angles, but remains valid for moving targets. Note that this antenna system is used as a single electronically translatable element with an omnidirectional pattern. The “blade” may be oriented to line up with the fuselage of an aircraft, for example.

With phase coherent signaling, it is possible to measure the difference in the distance to the tag from each antenna position. Signals from the two antenna elements are passed through an element selector switch commutating at the packet rate or an integer submultiple thereof. If, for example, the airborne receiver can resolve signal phase differences to 1 degree of arc, then the angle to the source may also be resolved to about 1 degree. This is not sufficient for precisely locating the target, but additional signal exchanges while in route can guide the system to the target. The observed Doppler shift is used to compensate for the phase differences occurring from the passage of time between captured packets, resulting in phase differences from element relative position only.

Note that the apparatus uses successive packets whose content is known at the platform's receiver so that the signal correlation functions are directly comparable. To have directly comparable correlation functions also requires that the packets have very similar spectral densities. As such, the preferred embodiment uses identical successive packets for this system. As an alternative different packets of the same length from the same sequence family may be used, as they would then yield the same correlation properties.

Where the packets are composed of lengthy codes, and we switch at synchronous or integer sub-synchronous packet rates, the captured sequences are, from a source point of view, identical. The difference between these pairs of captures will be only random noise, monopole location, and the translation of the airborne platform in one packet time. The translation effect is easily backed out in the processing by looking at the Doppler shift elsewhere in the capture (non-commutating). With the present system, packet synchronous antenna element switching, and 157 microsecond packets, if the aircraft is experiencing one-way Doppler shift corresponding, say, to 10 meters/second, then the time compensation would be 157*10̂-6 seconds*10 meters/second, or 1570 microns. This would in turn correspond to a phase shift between capture halves of 0.00157 meter/lambda, which in this case is about 32 cm. Thus, the phase shift compensation in this example will be about 0.0049 lambda, or 1.77 degrees. This compensation is applied to remove the effects of motion, giving phase/time estimates influenced only by antenna element positions and by noise.

If this antenna array is now intentionally skewed slightly, say 10 degrees from fore and aft, the ambiguity observed with static targets can be easily resolved, since the captures will be phase asymmetric for a tangential fly-by, for example. This symmetry breaking resolves the two-fold ambiguity with static tags.

At broadside incidence, the antenna elements will be different distances from the tag. If the elements are ¼ wave apart and are skewed 10 degrees from fore and aft, then the time difference between antennas will be about (lambda/4)*sin(10 degrees) which is about 1.3 centimeters at 915 MHz or 15 degrees of phase difference. This phase difference is easily detected. It should be noted that the signals would be skewed in either direction, so the question becomes “which signal came first?”

This system will, in the vast majority of situations, yield single shot positioning of static and dynamic targets.

To implement this, an airborne locator needs to capture interleaved sets of packets, and correctly Doppler process them, doubling the required Doppler processing. In addition, new code must process the added information and deliver the interferometric angle estimate and compare it with the Doppler calculated angles. A discrepancy of a certain size will indicate that the targeted tag is in motion. This indication will be displayed, and a greater tangential uncertainty will be noted. A comparison will be made between the angles derived from AOA and from Doppler. When those angles again agree, the system will decide that the tag(s) are no longer moving, and will transition to use of the more accurate Doppler derived angle information. To further enhance accuracy, the tags may transmit their barometer data in the return data stream to the airborne locator. In certain situations, this will help to correctly identify positions.

The two-element UHF blade antenna, whose width, assuming a 915 MHz operating frequency, could be as little as 1.3 cm, will incorporate a compass, easing alignment issues, especially since the aircraft may be “crabbing” in crosswinds. Angle of arrival, after all, is referenced to an antenna orientation rather than a direction of travel.

The system's sequences need not be altered in any way, and connected or un-connected modes are unchanged.

The addition of AOA to the existing TOA and Doppler modes increases capability considerably without the need of bulky antenna arrays.

The two element antenna is closely spaced, to minimize mounting and other difficulties. The short element spacing is made practical by tuning the base impedance of the unselected element(s) to be very high. This, as is known, drastically reduces the scattering cross section of the unused element(s) so that the pattern remains essentially circular about the connected element. Otherwise, the pattern would be distorted, preventing accurate AOA determination.

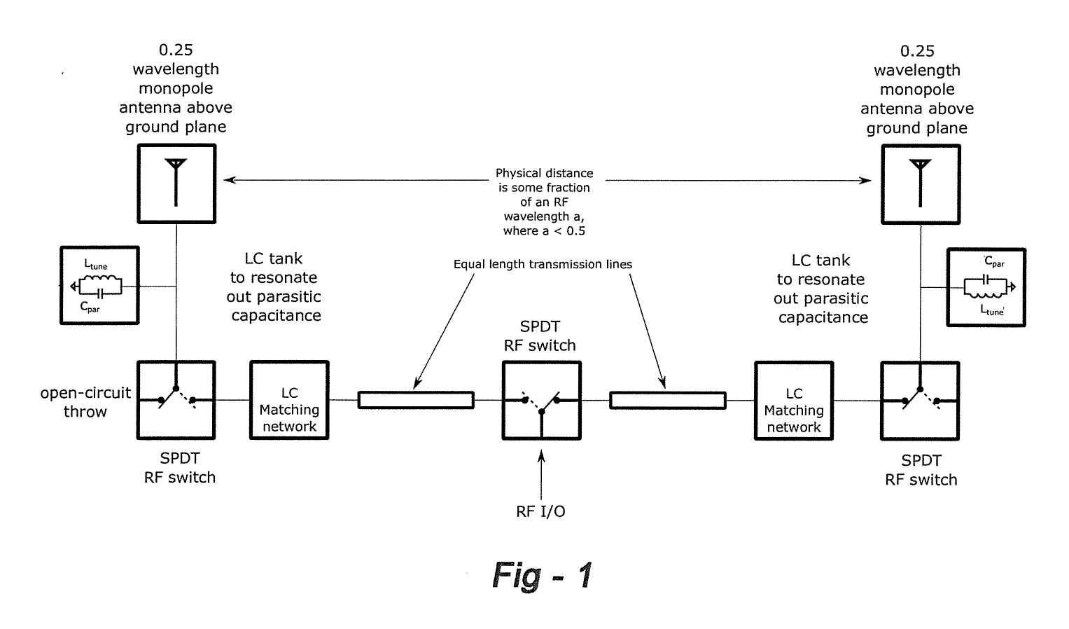

A switching system connects one element to the airborne locator's receiver, whilst terminating the other element in an open circuit. It isn't necessary to switch the antennas while transmitting. FIG. 1 is a simplified block diagram that shows a pair of ¼ wave monopoles above a ground plane. The antennas are resonated with LC tanks, where the C is parasitic capacitance of the switch and wiring, so that when the SPDT RF switch associated with each antenna is in the open circuit position, very little or no current flows through the base of the unselected antenna. This drastically reduces the scattering at the antenna center frequency, in turn making the unselected antenna “invisible” from an RF cross section point of view.

The other side of each of the paired SPDT RF switches connects to an impedance matching network which transforms the base impedance of each monopole to the characteristic impedance of the equal length transmission lines which is usually the impedance of the external RF cable. The central RF switch selects which antenna is active. The switch throws shown are for the right antenna to be active. This arrangement results in an antenna whose effective physical position can be very rapidly moved electronically. This is normally done at the sequence rate or an integer submultiple (in our exemplary case, about every sequence time which is 2047 symbols/157 microseconds).

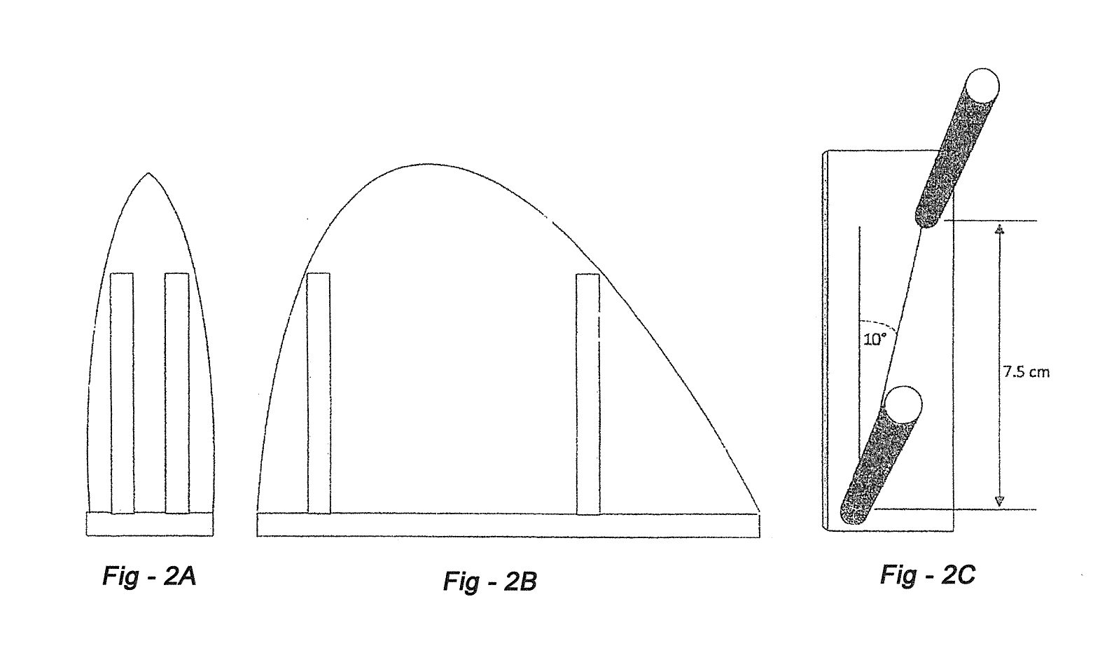

FIG. 2 shows different views of regarding mechanical aspects of the invention. The ¼ wave antenna rods mount into a printed circuit board. A tiny “radome” covers the assembly, providing protection from wind & rain and making the assembly aerodynamically compatible with high speed flight.

Of course, the techniques described herein may be extended to the use of larger arrays of elements, with only one element selected at any time. In those cases, the unselected elements are made “invisible” by setting their base impedances to be essentially open circuits. It is unlikely that large arrays would be used, since further improvement of angular resolution is generally unnecessary. The intent here is to provide AOA information from a narrow, compact single antenna assembly which is easy to install and inconspicuous.

An analogous device for terrestrially based locators is the “lariat” mode locator which can reliably locate moving or static targets by synthesizing an antenna array from sequential positions of the single spinning antenna element. The synthesized circular antenna array there assumes a repeating signal sequence, as in the present invention. The other elements of course need not be made electrically invisible, since they are the same single element in multiple positions. That device also will have indication of motion toward or away from the locator.

The accuracy of the system when tracking a moving target is directly related to the accuracy of the AOA measurement. At short to moderate distances, the limiting factor is not the signal/noise ratio. Rather, the accuracy will be governed by the matching of the antenna elements and the surrounding environment, namely, the body or “skin” of the vehicle that is the host for the antenna. The body may contain any number of protuberances or structural features that will interact with the radiation from the antenna, thus altering and distorting the AOA measurement. To minimize these errors, each specific antenna-vehicle pairing can be accurately characterized. The specific antenna characteristics are then used to correct for the aforementioned AOA distortion.

Characterization of the antenna can be performed quickly and accurately using existing system components. As mentioned previously, AOA measurements are not required for locating a static tag. Under these conditions, Doppler readings and AOA readings should be equal. Accordingly, a calibration table for the specific antenna is easily derived by taking the difference between the Doppler reading and the AOA reading. This operation is performed over a range of observation angles spanning at least 360 degrees with an interval of approximately 10 degrees. The operation may also be iterated over a range of elevation angles to derive a 3-dimentional correction table.

The calibration also provided improvements in long-term system accuracy. Vibration and environmental factors can cause the antenna characteristics to change over time. The calibration process restores the accuracy of the system. The calibration process can also be used as a diagnostic tool to evaluate the ongoing performance of the antenna. Calibration readings falling outside of a prescribed limit indicate that the antenna is not performing properly or has been damaged.

1. Apparatus for accurately locating a tag, including a moving tag, transmitting packets of information at a packet rate using phase-coherent signaling on a carrier frequency, the apparatus comprising:
at least two antenna elements having fore and aft positions relative to a tag to be located;
wherein the antenna elements are spaced apart by about a ¼ to ½ wave of the carrier frequency;
electronic circuitry receiving signals from the antenna elements, the electronic circuitry being operative to correlate the signals to determine an angle of arrival (AOA) and the difference in the distance to the tag from each antenna position.

2. The apparatus of claim 1, including successive packets whose content is known so that the signal correlation functions are directly comparable.

3. The apparatus of claim 2, wherein the received packets have very similar spectral densities.

4. The apparatus of claim 3, wherein the received packets are identical or of the same length from a common sequence family.

5. The apparatus of claim 1, wherein the antenna elements are skewed from fore to aft to resolve ambiguity observed with a target that is not moving.

6. The apparatus of claim 1, wherein the antenna elements are skewed by about 10 degrees from fore to aft to resolve ambiguity observed with a target that is not moving.

7. The apparatus of claim 1, further including an antenna element selector switch to commutate the signals from the two antenna elements at the packet rate or an integer submultiple thereof.

8. The apparatus of claim 7, wherein:
the packets are composed of lengthy codes; and
the switching occurs at synchronous or integer sub-synchronous packet rates such that the captured sequences are substantially identical from a source point of view.

9. The apparatus of claim 1, including electronic circuitry operative to perform the following functions:
derive an angle to the tag based upon Doppler processing;
compare the derived angle to the AOA; and
if the difference between the derived angle and the AOA is above a predetermined discrepancy, assume the target is moving and use the AOA as an angle measurement; or
if the derived angle and the AOA are in agreement, assume the tag is static and use the Doppler derived angle information.

10. The apparatus of claim 9, wherein the electronic circuitry operative is operative to:
perform multiple comparisons between Doppler and AOA measurements;
generate a correction table based upon the multiple comparisons; and
develop a calibration algorithm that applies the correction table to subsequent readings.

11. The apparatus of claim 10, wherein the multiple comparisons are performed with a static reference tag and a moving locator platform.

12. The apparatus of claim 10, wherein the multiple comparisons are based upon the difference between Doppler and AOA readings over a range of observation angles spanning at least 360 degrees.

13. The apparatus of claim 9, wherein the observed Doppler shift is used to compensate for the phase differences occurring from the passage of time between captured packets, resulting in phase differences from element relative position only.

14. The apparatus of claim 1, further including an electronic compass to determine the alignment of the antenna elements.

15. The apparatus of claim 1, including a tag operative to transmit barometric data.

16. The apparatus of claim 1, wherein the antenna elements have a post or blade shape.

17. The apparatus of claim 1, wherein the antenna elements are aligned with the fuselage of an aircraft.
